(19) United States
(12) Patent Application Publication
(10) Pub. No.: US 2013/0273342 A1
(43) Pub. Date: Oct. 17, 2013

(54) GEL SEALING CORROSION PREVENTION TAPE

(71) Applicants: Michael A. Johnson, Stillwater, MN (US); Steven L. Falteisek, Hudson, WI (US)

(72) Inventors: Michael A. Johnson, Stillwater, MN (US); Steven L. Falteisek, Hudson, WI (US)

(73) Assignee: 3M INNOVATIVE PROPERTIES COMPANY, St. Paul, MN (US)

(21) Appl. No.: 13/988,563

(22) PCT Filed: Dec. 22, 2011
(86) PCT No.: PCT/US11/66806

§ 371 Date: May 21, 2013

Related U.S. Application Data
(60) Provisional application No. 61/427,357, filed on Dec. 27, 2010.

(51) Int. Cl. C09J 109/00; C08F 136/06

(52) U.S. Cl. CPC C09J 109/00; C08F 136/06
USPC 428/220; 525/131; 524/572; 523/219

(57) ABSTRACT

A deformable tacky polyurethane polymer is provided which is the reaction product of a polyisocyanate, a polyol, and a mono-hydroxy tackifier. In addition, compositions pare provided comprising a polymer according to the present disclosure and one or more of: surface modified silica nanoparticles, glass bubbles and fiber filler particles. In addition, a flexible gasketing tape is provided comprising a polymer according to the present disclosure or a composition according to the present disclosure.

### CROSS REFERENCE TO RELATED APPLICATION

This application claims the benefit of U.S. Provisional Patent Application No. 61/427,357, filed Dec. 27, 2010, the disclosure of which is incorporated by reference herein in its entirety.

### FIELD OF THE DISCLOSURE

This disclosure relates to polymers and compositions that may be useful as flexible gasketing materials.

### BACKGROUND OF THE DISCLOSURE

Some known flexible gasketing materials are used on aircraft to seal voids between floorboards, access panels, exterior panels, fittings, fixtures such as antenna, and other openings and seams and their related structures. The gaskets prevent fluids from reaching critical areas and causing corrosion, electrical shorts or systems malfunctions by their presence.

U.S. Pat. No. 6,586,483 B2, discloses certain surface-modified nanoparticles and uses thereof.

### SUMMARY OF THE DISCLOSURE

Briefly, the present disclosure provides a deformable tacky polyurethane polymer which is the reaction product of a polyisocyanate, a polyol, and a mono-hydroxy tackifier. In some embodiments, the mono-hydroxy tackifier is a compound which may be derived from resin. In some embodiments, the mono-hydroxy tackifier is a compound which may be derived from rosin. In some embodiments, the mono-hydroxy tackifier is a compound which may be derived from a resin acid. In some embodiments, the mono-hydroxy tackifier is a compound which is polycyclic. In some embodiments, the mono-hydroxy tackifier is a compound which is triycyclic. In some embodiments, the mono-hydroxy tackifier has a molecular weight of greater than 200. In some embodiments, the mono-hydroxy tackifier has a molecular weight of greater than 250. In some embodiments, the mono-hydroxy tackifier is hydroabietyl alcohol. In some embodiments, the polyisocyanate is a multifunctional polyisocyanate having a functionality of greater than 2. In some embodiments, the polyol has a molecular weight of greater than 500. In some embodiments, the polyol has a molecular weight of greater than 700. In some embodiments, the polyol is a hydroxyl-terminated polybutadiene.

In another aspect, the present disclosure provides compositions comprising a polymer according to the present disclosure and one or more of: surface modified silica nanoparticles, glass bubbles and fiber filler particles.

In another aspect, the present disclosure provides a flexible gasketing tape comprising a polymer according to the present disclosure or a composition according to the present disclosure

### DETAILED DESCRIPTION

The present disclosure provides a low density, fire-retardant, flowable, polyurethane gel tape that is capable of sealing aircraft structures from a variety of fluids, and preventing corrosion through the various environments encountered on aircraft. The present disclosure additionally provides a two-part, reactive gel composition based on the same chemistry. The present disclosure additionally provides a kit comprising the gel tape and the two-part, reactive gel composition which may be useful in sealing a variety assemblies, including those found on aircraft.

The gel-like tape herein may exhibit characteristics of being tacky, compressibly flowable, corrosion resistant, flame retardant, low in specific gravity (for weight savings), exhibiting no appreciable increase in adhesion over time, and having sufficient cohesive strength to be easily and cleanly removed from a solid substrate upon disassembly.

In some embodiments, the deformable polyurethane composition according to the present disclosure is produced from a reaction mixture including: a multi-functional isocyanate, a high molecular weight hydroxyl-terminated polybutadiene, a mono-hydroxy functional tackifier and a polyurethane catalyst. In some embodiments, the reaction mixture additionally includes a low molecular weight alcohol. In some embodiments, the reaction mixture additionally includes one or more of: inorganic fiber filler and chopped inorganic or organic random fibers. In some embodiments, the reaction mixture additionally includes one or more of: glass bubbles and surface modified nanoparticles. In some embodiments, the reaction mixture additionally includes a plasticizer. In some embodiments, the reaction mixture additionally includes an antioxidant.

In one embodiment, the deformable polyurethane composition according to the present disclosure includes: a multi-functional isocyanate such as Desmodur N3300 from Bayer Corp., a high molecular weight hydroxyl-terminated polybutadiene such as Poly BD R45HTLO from Sartomer Corp., a mono-hydroxy functional tackifier such as Abitol E from Eastman Chemical Company, a low molecular weight alcohol such as 2-ethyl-1-hexanol from Alpha Aesar Company, dibutyl tin dilaurate polyurethane catalyst Dabco T-12 from Air Products Inc., a phosphated plasticizer such as Phosflex 31L from Supresta Company, glass bubbles from 3M, 5 nanometer surface modified nanoparticles from 3M, Wollastonite inorganic fiber filler from R.T. Vanderbilt Company, Irganox 1010 antioxidant from Ciba Corporation, and chopped inorganic or organic random fibers such as ¼″ chopped Polyester fibers.

Any suitable multi-functional isocyanate may be used. Examples include Desmodur N3300 from Bayer Corp. The multi-functional isocyanate is used to produce a final crosslinked, thermoset polyurethane composition. Multi-functional means the isocyanate has on average more than two isocyanate groups per molecule. Some embodiment utilize di-isocyanates, which have a functionality of two lead to linear polyurethanes when reacted with diols, which also have a functionality of two. Some embodiments have an average functionality, between the isocyanate and polyol components, of greater than 2.0, leading to a crosslinked, thermoset polyurethane.

Any suitable polyol may be used. Examples include Poly BD R45HTLO from Sartomer Corp. In some embodiments, the polyol component of the polyurethane composition relies on a hydroxyl terminated polybutadiene which provides for a final composition with a very low glass transition temperature and insures that the adhesive characteristics of the composition are relatively uniform over a large range in temperature.

Any suitable tackifier may be used. Typically, the tackifier component is designed specifically to react into the polyurethane composition and simultaneously allow the total system functionality to be reduced. Being mono-functional serves to regulate the degree of polymerization of the composition and allow for an overall balance of properties. Other non-reactive tackifiers can also be utilized to strike a balance in adhesion performance.

In some embodiments, a low molecular weight mono-alcohol is also incorporated. This may serve a similar fashion as the reactive tackifier but avoids directly affecting the adhesive properties of the composition.

In some embodiments, a plasticizer is incorporated into the composition to strike a balance in the adhesive and mechanical properties of the sealant and also impart flame retardance characteristics to the composition.

In some embodiments, Wollastonite inorganic fibers are incorporated to improve the cohesive strength of the composition so that when end-of-life occurs for the sealant tape it can be easily removed. These fibers provide small scale reinforcement to the composition. These may be used in conjunction with chopped inorganic or organic fibers, which provide larger scale reinforcement to the composition. Each reinforcement when combined is capable of striking a cohesive balance to the polyurethane composition.

In some embodiments, glass bubbles are incorporated to reduce the specific gravity of the sealant for weight savings, which can be particularly beneficial in the aerospace industry.

In some embodiments, surface modified nanoparticles are incorporated into the composition as gas stabilizers for the purpose of frothing. Frothing provides additional weight savings and simultaneously enables the composition to be more rheologically responsive when the polyurethane gel tape is placed in compression.

In some embodiments, an antioxidant is incorporated into the composition to provide oxidative stability. In some embodiments, Irganox 1010 antioxidant is incorporated.

The polyurethane gel tape may be produced by any suitable method. In one embodiment, the polyurethane gel tape is produced by a process that relies on mixing the isocyanate and polyol and directly casting the composition between top and bottom process liners. In some embodiments, the liners are removed. In some embodiments, one liner is removed and the other is left as part of the product construction. In some embodiments, both liners are left as part of the product construction.

In some embodiments, the deformable polyurethane composition is a sheet, in some embodiments having a thickness of less than 10 mm, more typically less than 5 mm, and more typically less than 1 mm. Such a sheet typically has a thickness of at least 10 microns, more typically at least 20 microns, and more typically at least 30 microns. In some embodiments the sheet of deformable polyurethane forms a layer of a multi-layered structure, whose other layers are, in some embodiments, fluoropolymer sheets. In some embodiments the sheet of deformable polyurethane forms a layer of a two-layered structure, whose other layer is a fluoropolymer sheet. In some embodiments the sheet of deformable polyurethane forms a layer of a multi-layered structure, whose other layers are, in some embodiments, sheets of poly(ethylene-co-methacrylic acid) ionomer film. In some embodiments the sheet of deformable polyurethane forms a layer of a two-layered structure, whose other layer is a sheet of poly(ethylene-co-methacrylic acid) ionomer film.

Objects and advantages of this disclosure are further illustrated by the following examples, but the particular materials and amounts thereof recited in these examples, as well as other conditions and details, should not be construed to unduly limit this disclosure.

### EXAMPLES

Unless otherwise noted, all reagents were obtained or are available from Aldrich Chemical Co., Milwaukee, Wis., or may be synthesized by known methods.

The following abbreviations are used to describe the examples:

° C.: degrees Centigrade

° F.: degrees Fahrenheit

cm: centimeters

g/cm·w grams per centimeter width

kg: kilogram

lb: pound

mil: 10⁻³ inches

mm: millimeters

μm: micrometers

nm: nanometers

oz/in·w ounces per inch width

rpm: revolutions per minute

### Materials Used:

10P4-2: A green epoxy primer, obtained under the trade designation “10P4-2” from AkzoNobel Aerospace Coatings, Amsterdam, Netherlands.
10P4-3: A yellow epoxy primer, obtained under the trade designation “10P4-3” from AkzoNobel Aerospace Coatings.
POLY-BD: A hydroxyl terminated polybutadiene resin, obtained under the trade designation “POLY BD R-45HTLO” from Sartomer Company, Inc., Exton, Pa.
ABITOL-E: A monohydroxy functional hydroabietyl alcohol tackifier, obtained under the trade designation “ABITOL E” from Eastman Chemical Company, Kingsport, Tenn.
CCF: 6 mm chopped nickel coated carbon fiber, obtained under the trade “TENAX-J HT C903 6MM” from Toho Tenax Europe GmbH, Wuppertal, Germany.
CPF1: 0.25-inch (6.35 mm) 1.5 denier chopped uncrimped polyester fiber, obtained from Stein Fibers, Ltd., Albany, N.Y.
CPF2: 0.118-inch (3.0 mm), 1.5 denier chopped uncrimped polyester fiber, obtained from William Barnet and Son, LLC, from Arcadia, S.C.
DESMODUR: A multifunctional isocyanate obtained under the trade designation “DESMODUR N3300” from Bayer MaterialScience, LLC, Pittsburgh, Pa.
DBTDL: Dibutyltin dilaurate, obtained under the trade designation “DABCO T-12” from Air Products & Chemicals, Inc., Allentown, Pa.
EPT 22/23: An white epoxy topcoat paint, obtained under the trade designation “22/23 SERIES HIGH SOLIDS EPOXY TOPCOAT” from AkzoNobel Aerospace Coatings.
IOTMS: Isooctyltrimethoxysilane, obtained from Gelest, Inc., Morrisville, Pa.
IRGANOX: Pentaerythritol tetrakis(3-(3,5-di-tert-butyl-4-hydroxyphenyl)propionate), obtained under the trade designation “IRGANOX 1010” from BASF Corporation, Florham Park, N.J.
K1-GB: Glass bubbles, obtained under the trade designation “K1 GLASS BUBBLES” from 3M Company, St. Paul, Minn.
MTMS: Methyltrimethoxysilane, obtained from Gelest, Inc.
N2326: An aqueous 5 nm colloidal silica dispersion, 16.06% solids, obtained under the trade designation “N2326” from Nalco, Naperville, Ill.
N-MEFBSE: 1-Butanesulfonamide,1,1,2,2,3,3,4,4,4-nonafluoro-N-(2-hydroxyethyl)-N-methyl.

### OOD: 1-Octadecanol.

PHOSFLEX: A substituted triaryl phosphate ester plasticizer, obtained under the trade designation “PHOSFLEX 31L” from ICL Industrial Products, Tel Aviv, Israel.
SMSN: 85:15 weight percent isooctyltrimethoxysilane:methylmethoxysilane modified 5 nm silica nanoparticles, synthesized as follows. 100 grams Nalco 2326 colloidal silica, 7.54 grams of IOTMS, 0.81 grams of MTMS and 112.5 grams of an 80:20 weight percent blend of ethanol:methanol were added to a 500 ml 3-neck round bottom flask equipped with a stirring assembly, thermometer and condenser. The flask was placed in an oil bath set at 80° C. and stirred for 4 hours, after which the mixture was transferred to a crystallizing dish and dried in a convection oven set at 150° C. for 2 hours.
SMSN-PFX: A 10% by weight dispersion of SMDN in PHOSFLEX.
SURLYN: A 2 mil (50.8 μm) clear poly(ethylene-co-methacrylic acid) ionomer film, obtained under the trade designation “SURLYN CLEAR XIO 94.2” from Berry Plastics Corporation, Evansville, Ind.
TEH: 2-Ethyl-1-hexanol, obtained from Alfa Aesar Company, Ward Hill, Mass.
WFF: Wollastonite inorganic fiber filler, obtained under the trade designation “VANSIL W-40” from R.T. Vanderbilt Company, Inc., Norwalk, Conn.

### Example 1

Except where noted, the following components were pre-heated to 158° F. (70° C.) prior to addition: 2.07 grams TEH was added to a mixing cup, type “MAX 100”, obtained from Flacktek, Inc., Landrum, S.C. 20.30 grams POLY-BD, degassed under vacuum for 180 minutes at 60° C. in an oven, model “ADP21” from Yamato Scientific America, Inc., Santa Clara, Calif., was added to the mixing cup, followed by 22.28 grams PHOSFLEX and 10.47 grams ABITOL-E. 0.21 grams OOD was then slowly added, drop wise, to the mixture. The cup was placed on a hotplate, set to approximately 200° F. (93.3° C.), for 30 minutes. The mixture was then blended until homogeneous by slowly stirring for 2 minutes with an air-driven mixer, model “1AM-NCC-12”, obtained from Gast Manufacturing, Inc., Benton Harbor, Mich. 50.31 grams of this pre-blend mixture was then transferred to another MAX 100 mixing cup, followed by 1.08 grams SMSN, 1.28 grams IRGANOX, 2.00 grams K1-GB, 6.10 grams WFF and 4.00 grams CPF1, after which the mixture was placed in an oven set at 158° F. (70° C.) for 30 minutes. Upon removal from the oven the cup was then placed in a mixer, model number DAC 150 FV, obtained from Flactek, and the mixture blended at 3,540 rpm for one minute, until homogeneous. The cup was removed from the mixer and 10.30 grams DESMODUR was added to the composition, followed by, drop wise, 0.15 grams DBTDL. The cup was returned to the mixer and blended for one minute at 3,540 rpm for one minute, until homogeneous. The composition for this and the following examples are summarized in Table 1.

The composition was coated between two mil (50.4 μm) silicone coated polyester release liners using a laboratory roll coater, at a nominal gap of 49 mils (1.25 mm). The coating was cured at 158° F. (70.0° C.) for 16 hours, resulting in a gel tape having a film thickness of approximately 45 mils (1.14 mm).

### Example 2

The general procedure as described in Example 1 was repeated, wherein the 4.00 grams CPF1 was replaced with 12.03 grams CCF.

### Example 3

The general procedure as described in Example 1 was repeated, wherein one of the polyester liners was replaced with a sheet of 2 mil (50.8 μm) SURLYN film.

### Example 4

0.94 grams TEH was added to a MAX 40 mixing cup, followed by 9.23 grams POLY-BD, 10.13 grams PHOSFLEX, 5.00 grams ABITOL-E (pre-heated to 158° F. (70° C.)), 0.54 grams SMSN, 0.63 grams IRGANOX, 1.00 gram K1-GB, 3.05 grams WFF and 2.00 grams CPF1. The mixing cup was then placed in the DAC 150FV mixer and blended at 3,540 rpm for 45 seconds until homogeneous. The cup was removed from the mixer and 10.30 grams DESMODUR was added to the composition, followed by, drop wise, 0.09 grams DBTDL. The cup was returned to the mixer and blended for one minute at 3,540 rpm for 45 seconds, until homogeneous. A gel tape was then made from the composition according to the process described in Example 1.

### Example 5

The general procedure as described in Example 1 was repeated, according to the composition listed in Table 1, wherein 0.21 grams OOD was replaced with 0.37 grams N-MEFBSE and the amount of pre-blend adjusted to 50.50 grams.

### Example 6

The general procedure as described in Example 5 was repeated, wherein one of the polyester liners was replaced with a sheet of 2 mil (50.8 μm) SURLYN film.

### Example 7

The general procedure as described in Example 1 was repeated, according to the composition listed in Table 1, wherein the SMSN was pre-dispersed in PHOSFLEX, CPF1 was replaced by CPF2, the WFF was substituted by an increased amount of K1-GB and the pre-blend was reduced from 50.31 to 48.81 grams.

TABLE 1

| Component | Example | | | | | | |
|---|---|---|---|---|---|---|---|
| (grams) | 1 | 2 | 3 | 4 | 5 | 6 | 7 |
| TEH | 2.07 | 2.07 | 2.07 | 0.94 | 1.88 | 1.88 | 1.88 |
| POLY-BD | 20.30 | 20.30 | 20.30 | 9.23 | 18.46 | 18.46 | 18.46 |
| PHOSFLEX | 22.28 | 22.28 | 22.28 | 10.13 | 20.26 | 20.26 | 16.37 |
| ABITOL-E | 10.47 | 10.47 | 10.47 | 5.00 | 9.54 | 9.54 | 7.57 |
| OOD | 0.21 | 0.21 | 0.21 | 0 | 0 | 0 | 0.24 |
| IRGANOX | 1.28 | 1.28 | 1.28 | 0.63 | 1.28 | 1.28 | 1.28 |
| K1-GB | 2.00 | 2.00 | 2.00 | 1.00 | 2.00 | 2.00 | 5.00 |
| SMSN | 1.08 | 1.08 | 1.08 | 0.54 | 1.08 | 1.08 | 0 |
| WFF | 6.10 | 6.10 | 6.10 | 3.05 | 6.10 | 6.10 | 0 |
| CPF1 | 4.00 | 0 | 4.00 | 2.00 | 4.00 | 4.00 | 0 |
| CPF2 | 0 | 0 | 0 | 0 | 0 | 0 | 3.35 |
| DBTDL | 0.15 | 0.15 | 0.15 | 0.09 | 0.15 | 0.15 | 0.09 |
| DESMODUR | 10.30 | 10.30 | 10.30 | 5.10 | 10.21 | 10.21 | 10.30 |
| CCF | 0 | 12.03 | 0 | 0 | 0 | 0 | 0 |
| N-MEFBSE | 0 | 0 | 0 | 0 | 0.37 | 0.37 | 0 |
| SMSN-PFX | 0 | 0 | 0 | 0 | 0 | 0 | 4.32 |

### Test Methods

The examples of gel tape were evaluated according to the test methods described below, the results of which are listed in Table 2.

### Room Temperature Peel Strength: Examples 1-6

A 2 by 5 inches by 43.2 mil (50.8 by 127.0 by 1.1 mm), stainless steel test coupon, obtained from Cheminstruments, Inc., Fairfield, Ohio. The exposed face of the coupon was wiped with isopropyl alcohol and allowed to dry. The liner was removed from one side of the gel tape example and the exposed face of the gel tape manually laminated over the cleaned surface of the stainless steel coupon using the 4.5 lb (2.04 kg) weighted roller, also obtained from Cheminstruments, Inc. The test sample was then held at 70° F. (21.2° C.) for 24 hours before measuring the peel strength according to ASTM D3330.

### Heat Soaked Peel Strength

### Examples 1-6

The general procedure as described in the room temperature peel test was repeated, wherein, after laminating the gel tape to the stainless steel test coupon, the test sample was placed in an oven set at 54° C. for 7 days. After removing the test sample from the oven it was held for 24 hours at 70° F. (21.2° C.) before performing the peel strength test according to ASTM D3330.

### Room Temperature and Heat Soaked Peel Strength

### Example 7

The general procedures for determining peel strengths described above were repeated, wherein the stainless steel coupons were substituted with treated aluminum coupons as follows. A 2 by 5 inches by 63 mil (50.8 by 127.0 cm by 1.60 mm), 7075T6 clad aluminum coupon, obtained from Erickson Metals, Coon Rapids, Minn., was manually scoured with a nonwoven pad, wiped with isopropyl alcohol and dried. The coupon was then sprayed with 10P4-2 green primer and allowed to dry for approximately 16 hours at 70° F. (21.2° C.). A second aluminum coupon was treated with 10P4-3 yellow primer in a similar fashion, as was a third coupon that was treated with white top coat. The results for peel strengths reported in Table 2 represent the average of one test each on treated coupon.

### Moisture Absorption Test

An aluminum coupon, 1 by 10 inches of nominal thickness 63 mil, (2.54 by 25.2 cm by 1.60 mm) was cleaned with “NOVEC CONTACT CLEANER, Part No. 71699”, obtained from 3M Company, dried and weighed. The liner was removed from one side of a 10 by 1 inch sample of gel tape and the exposed face of the gel tape manually laminated over the cleaned surface of the aluminum coupon using a 4.5 lb (2.04 kg) weighted roller. The release liner was removed from the second face of the gel tape and the test sample placed in a conditioning chamber set at 75° F. (23.9° C.) for 24 hours at 50% relative humidity. The test sample was removed from the conditioning chamber, weighed, then placed in another conditioning chamber set at 120° F. (48.9° C.) for 7 days at 95% relative humidity. After removing from the conditioning chamber the gel tape surface was gently blotted dry with gauze, and the test sample reweighed in order to calculate the percentage weight gain.

TABLE 2

| | Peel Strength | | |
|---|---|---|---|
| | oz/in · w (g/cm · w) | | % Moisture |
| Example | Room Temperature | Heat Soaked | Absorption |
| 1 | 5.32 (59.38) | 8.21 (91.63) | 0.284 |
| 2 | 6.71 (74.89) | 14.35 (160.16) | 0.260 |
| 3 | 10.33 (115.30) | 16.00 (178.58) | 0.183 |
| 4 | 5.06 (56.48) | 27.61 (308.16) | Not evaluated |
| 5 | 7.66 (85.49) | 11.27 (125.79) | 0.355 |
| 6 | 5.34 (59.60) | 28.40 (316.98) | 0.500 |
| 7 | 4.56 (50.90) | 9.75 (108.92) | 0.21 |

Various modifications and alterations of this disclosure will become apparent to those skilled in the art without departing from the scope and principles of this disclosure, and it should be understood that this disclosure is not to be unduly limited to the illustrative embodiments set forth hereinabove.

1. A deformable tacky polyurethane polymer which is the reaction product of a polyisocyanate, a polyol, and a mono-hydroxy tackifier.

2. The polymer according to claim 1 wherein the mono-hydroxy tackifier is a compound which may be derived from resin.

3. The polymer according to claim 1 wherein the mono-hydroxy tackifier is a compound which may be derived from rosin.

4. The polymer according to claim 1 wherein the mono-hydroxy tackifier is a compound which may be derived from a resin acid.

5. The polymer according to claim 1 wherein the mono-hydroxy tackifier is a compound which is polycyclic.

6. The polymer according to claim 1 wherein the mono-hydroxy tackifier is a compound which is tricyclic.

7. The polymer according to claim 1 wherein the mono-hydroxy tackifier has a molecular weight of greater than 200.

8. The polymer according to claim 1 wherein the mono-hydroxy tackifier has a molecular weight of greater than 250.

9. The polymer according to claim 1 wherein the mono-hydroxy tackifier is hydroabietyl alcohol.

10. The polymer according to claim 1 wherein the polyisocyanate is a multifunctional polyisocyanate having a functionality of greater than 2.

11. The polymer according to claim 1 wherein the polyol has a molecular weight of greater than 500.

12. The polymer according to claim 1 wherein the polyol has a molecular weight of greater than 700.

13. The polymer according to claim 1 wherein the polyol is a hydroxyl-terminated polybutadiene.

14. A composition comprising the polymer according to claim 1 and surface modified silica nanoparticles.

15. A composition comprising the polymer according to claim 1 and glass bubbles.

16. A composition comprising the polymer according to claim 1 and fiber filler particles.

17. A composition according to claim 15 additionally comprising surface modified silica nanoparticles.

18. A flexible gasketing tape comprising the polymer according to claim 1 having a thickness of greater than 0.5 mm and less than 5 MM.

19. A flexible gasketing tape comprising the composition according to claim 14 having a thickness of greater than 0.5 mm and less than 5 mm.

20. A composition according to claim 16 additionally comprising surface modified silica nanoparticles.
